(19) United States
(12) Patent Application Publication
(10) Pub. No.: US 2004/0074921 A1
(43) Pub. Date: Apr. 22, 2004

(54) System for controlled dispersion of a consumable product

(76) Inventors: Edwin A. Lips, St. Louis, MO (US); Jon S. Lips, Parker, CO (US)

Correspondence Address: MARSH, FISCHMANN & BREYFOGLE LLP, 3151 SOUTH VAUGHN WAY, SUITE 411, AURORA, CO, 80014, US

(21) Appl. No.: 10/642,511

(22) Filed: Aug. 15, 2003

Related U.S. Application Data
(60) Provisional application No. 60/404,053, filed on Aug. 16, 2002.

(51) Int. Cl. B67D 5/08

(52) U.S. Cl. 222/52

(57) ABSTRACT

A system and method provide for the dispensing of a consumable product according to product information provided with the product. The system may include a controller and an interface device configured to read a memory device included with the consumable product. Based on the product data read from the memory device the controller generates at least one control signal transmittable to a dispenser which in turn dispenses the consumable product in a desired manner.

### RELATED APPLICATIONS

This application claims priority under 35 U.S.C. § 119 to prior U.S. Provisional Patent Application Serial No. 60/404,053 filed on Aug. 16, 2002, the entirety of which is hereby incorporated by reference.

### FIELD OF THE INVENTION

The present invention relates to systems utilized to dispense predetermined amounts of consumable/depletable products. In particular, the invention relates to a dispensing system that includes an interface for receiving product information regarding a product to be dispensed, wherein the product information is included with a prepackaged replenishment of the consumable product.

### BACKGROUND OF THE INVENTION

Various dispensing systems exist in which predetermined amounts of one or more consumable products are controllably dispensed for immediate use or for use in a post-dispensing process (i.e., mixture with other products/components). For example, horticultural products may be dispensed in an irrigation system of one form or another for watering plants and other vegetation. These fertigation/chemigation systems may dispense a quantity of a product (e.g., dosage), from a refillable supply of the product on an as needed basis, upon demand, upon a predetermined time interval or on any other appropriate basis. Additionally, these systems may dispense these products volumetrically, by weight, or, by part count. In any case, the dispensed product typically comes in a pre-packaged form for use with the dispensing system. When the product is depleted or “consumed” a replenishment or refill product is provided to replace the depleted supply.

Often, a fertigation/chemigation system may be capable of dispensing a variety of similar horticultural products. For example, depending on the plant-type being cared for, the time of the year and environmental factors, different horticultural products are required to be injected at different rates, often to different parts or zones of the property in order to maximize health, growth or to fight pests, weeds, disease or other problems.

Other dispensing systems may include a medical patient infusion pump that controllably infuses any of a variety of medicines into an intra venous system. Accordingly, depending on the medicine to be dispensed, the rates and/or volume of the dispersed product may vary. Similar systems exist in industrial and food service industries. In short, a wide variety of dispensing systems exist in which the configuration may require adjustment to provide appropriate amounts of the product or to otherwise control the dispersion of that product.

### SUMMARY OF THE INVENTION

Accordingly, a primary objective of the present invention is to provide a dispensing system in which product information may be obtained from a prepackaged consumable product and employed to insure proper dispensing system configuration.

Another objective is to provide a dispensing system in which product information is available from a prepackaged consumable product to allow proper product identification and effective, efficient use of that product.

Another objective of the present invention is to provide a dispensing system in which unauthorized, expired, or otherwise improper products cannot be utilized.

Another objective is to provide a system that may be retrofit to existing dispensing systems to increase their efficiency.

These and additional objectives are indeed realized by the present invention in which a system for the controlled dispersion of a consumable product is described. The system includes a controller connectable to an interface reader device and a dispenser control device. The interface reader device is configurable for reading and/or receiving product data associated with a consumable product to be dispensed, and providing this data to the controller. The dispenser control device is configurable for selectively controlling the dispensing of the consumable product in a dispensing system. During operation, the controller processes product data from the interface reader device (also referred to as a product data interface) and generates and transmits to the dispenser control device at least one control signal for controlling the dispensing of the consumable product.

The system described herein may further include at least one user interface device and a memory connectable to the controller. The user interface may be employable for entering product data either as, or in addition to, the interface reader, as well as displaying information generated by the controller, which may be employable by a system user for manually operating the dispensing system. The memory may be employable for storing protocol utilized in the dispensing system as well as storing information relating to the operation and/or the use of the consumable product, such as time based log entries.

Additions and various refinements of the noted features exist. These refinements and additional features may be provided separately or in any combination. For instance, the dispensing system may be operable to controllably dispense liquid, solid, or gaseous materials. Furthermore, the dispensing system may be able to dispense these products by utilizing any quantitative measure including, inter alia, dispensing the product volumetrically, by part count, by mass, or, until a predetermined concentration of the product is present in a secondary mixture.

The product data interface may be any interface means that effectively transfers data associated with the replacement product to the dispensing system. The data interface may comprise any number of devices such as magnetic card and/or strip readers, as well as scanning devices. In one configuration of the invention, the product data may be read from a data storage device includable with the consumable product. The data storage device may include a card removable from the container of the product, which is then inserted and/or scanned by the reader. The memory device may be further configured as part of the container for the consumable product.

In one embodiment, the product data interface is a unit that may be retrofit into existing dispensing systems. In this regard, the product data interface may include memory devices as well as protocols for generating signals for receipt by the controller of the existing dispensing system. As will be appreciated, to be retrofit with an existing dispensing system, the product data interface may be individually designed for use with that specific dispensing system. That is, system interconnections and/or protocol to generate appropriate control signals (e.g., analog, digital etc) may be specifically tailored for an existing dispensing system. What is important is that various aspects of the present invention may be incorporated into existing dispensing systems.

In another configuration of the invention, automated interfaces may receive product data information from a replenishment product automatically upon insertion of the container for the consumable product into the dispensing system. For example, the dispenser may contain a cartridge type interface into which a replenishment product cartridge is inserted. In this regard, an electronic chip, a data card, or other data source associated with the replenishment product cartridge may be read by a data reader automatically upon its insertion into the dispenser. That is, the product information may be integrated with the product packaging allowing automated reading of the product information.

In another embodiment, the product data interface may include a manual interface in which a user manually enters product information from the replenishment product. For example, the product data interface may allow a user to enter a product data code associated with the prepackaged product. As will be appreciated, in this embodiment, the product data interface and a user interface of the dispensing system may be integrated into a single unit. However, for ease of use, preferred embodiments utilize more automated product data interfaces where a user engages a readable data source from the replenishment product with the product data interface. Additionally, where a large volume of information is included with a replenishment product, a data device that contains a readable memory is desirable. Non-limiting examples of readable memory that may be utilized include electronic chips and/or magnetic tape slide cards that may be read by an electronic reader. In any case, the readable memory device allows for transferring an increased volume of product information associated with the replenishment product to the controller. However, it will be appreciated that the dispensing system may contain a stored product information database within its memory structure, or, be able to access product data information through a communications network, such as the Internet. In this regard, the system may be able to utilize a small amount of information (e.g., a bar code, lot number, etc) to access extended/additional product information.

In another embodiment, the product data interface may include an RF (i.e., radio frequency) reader allowing for remote entry of product data from the prepackaged replenishment product. For example, a specialized wireless remote control, phone or other transmitting device may be utilized to transmit information to the dispensing system. In this regard, upon delivery of a replenishment product, product data information may be remotely entered without necessarily having direct access to the dispensing system. That is, product data information may be scanned or otherwise “read” from the prepackaged product and transferred to the product data interface of the dispensing system remotely.

The product data sources may be associated (i.e. interconnected) with the replenishment product in any appropriate manner. As will be appreciated the form and location of the product data source may depend upon, inter alia, the type of dispensing system utilized, the type of product data interface utilized as well as the size and/or packaging of the replenishment product. That is, the product data source may be removable from the packaging of a replenishment product for insertion into the product data interface. In one particular embodiment, the replacement product includes a data card associated with its labeling or packaging that may be disconnected from the packaging and engaged (e.g., swiped or scanned) with the data interface of the dispensing system. For example, a data card may be sealed beneath a label on the replenishment product such that a user may upon utilizing the replenishment product remove the card and engage it with the product data interface. Alternatively, a reader/scanner interconnected to the product data interface may be used to scan product data from a data source permanently connected to a replenishment product.

As noted above, the controller is operatively connected to the product data interface to allow the controller to receive product data information from a product data source and utilize this information to configure the dispenser system for dispensing the product. In this regard, the controller is operative to adjust the functioning of the dispenser or otherwise alter its operation in accordance with the information received. That is, the product information may include at least a one parameter that details usage of the product, such as product specific information and/or calibration information for the dispensing system. Product specific information may provide information regarding what product is being inserted into the dispensing system, the volume of the product being inserted into the system, the concentration of the product, the date the product was manufactured, and/or, without limitation, any other product-specific information that may be utilized by the dispensing system. For example, the product information may include volumetric data related to the product being inserted into the dispensing system. This volumetric data may allow the dispensing system to determine how many doses of the subject product are available for dispensing and, upon reaching the predetermined number of doses, the controller may shut down the dispensing system. Alternatively, at a predetermined point prior to depletion of the dispensable product, the controller may provide a user message through the user interface indicating that the consumable product is nearly depleted.

Calibration information for the dispensing system may include, inter alia, dosage information to allow the controller to dispense the product through the dispensing system at a desired rate as determined by the manufacturer, process settings for configuring one or more functions of the dispenser, and/or information as to the amount of product contained in the container (e.g., such that the system may cease operation upon product depletion). As will be appreciated, depending on the dispensing system and the replenishment product, the calibration information may include preset non-adjustable calibration parameters. That is, the product calibration information may automatically configure the dispensing system in a manner that cannot be adjusted by a user to ensure the product is utilized in a predetermined manner unless the system is overridden with appropriate codes or other similar interface to be controlled as deemed appropriate by the user. Alternatively, the calibration information may consist of suggested calibration information that may allow a user, through a user interface, to accept or override the suggested calibration information. Additionally, the calibration information and the product information may be used in combination for calibrating the dispensing system. For example, where a dispensing system dispenses a fluid additive into a fluid stream, fluid additive information (e.g., concentration) may be utilized with system specific information (e.g., injector size), which may be user provided, to controllably inject a desired amount of the additive into the fluid stream to achieve a desired fluid/additive mixture.

In another embodiment of the present invention, the controller may use product information to prevent utilization of a product in a manner that causes poor performance of the system, damage to the system, or possible damage to a recipient being served by the system, or otherwise prevent unauthorized/improper use of the dispensing system. For example, upon receiving product information through the product data interface, the controller may determine the product is not intended for use through an injection system, expired or otherwise incompatible with the dispensing system or other products contained within the system. In this case, the controller may deactivate the system, thereby preventing use of the non-acceptable product. Alternatively, the controller may require product data be received from a recognized replenishment product to activate the system. Additionally, the controller may only activate the dispensing system for a predetermined period (e.g., a number of doses as determined by volumetric information provided by the product data). Upon the time period expiring, a number of doses being dispensed, or the authorized product being removed from the system, the controller may deactive the system.

In another embodiment of the present invention, the product data may include user instructions for display on a user interface of the dispensing system. For example, the product data interface may receive configuration instructions requesting one or more user inputs through the user interface. That is, a series of instructions may prompt a user to enter dispensing system specific information that may be used with product information to properly configure the dispensing system for use with a product. For example, in a fluid injection system, a user may be prompted to enter flow rates of a fluid stream into which a dispensable product is being inserted. As will be appreciated, upon determining the flow rate, the controller may utilize concentration information associated with the injectable product data as well as any information in a system memory to determine an injection schedule/dosage that provides a desired mixture after injection. Though described in the above example as utilizing a single user input, it will be appreciated that depending on the complexity of the dispensing system and/or the product utilized, that a plurality of user instructions and/or interface prompts may be provided.

### BRIEF DESCRIPTION OF THE DRAWINGS

FIG. 1 shows a plan view of a dispensing system that incorporates a product data interface.

FIG. 2 shows a flow chart of a method for utilizing product data information received through a product data interface of a dispensing system.

FIG. 3 shows one embodiment of a product data interface incorporated into a horticulture liquid dispensing system.

FIG. 4 shows a slide card product data interface integrated into a controller of the system shown in FIG. 3.

### DETAILED DESCRIPTION

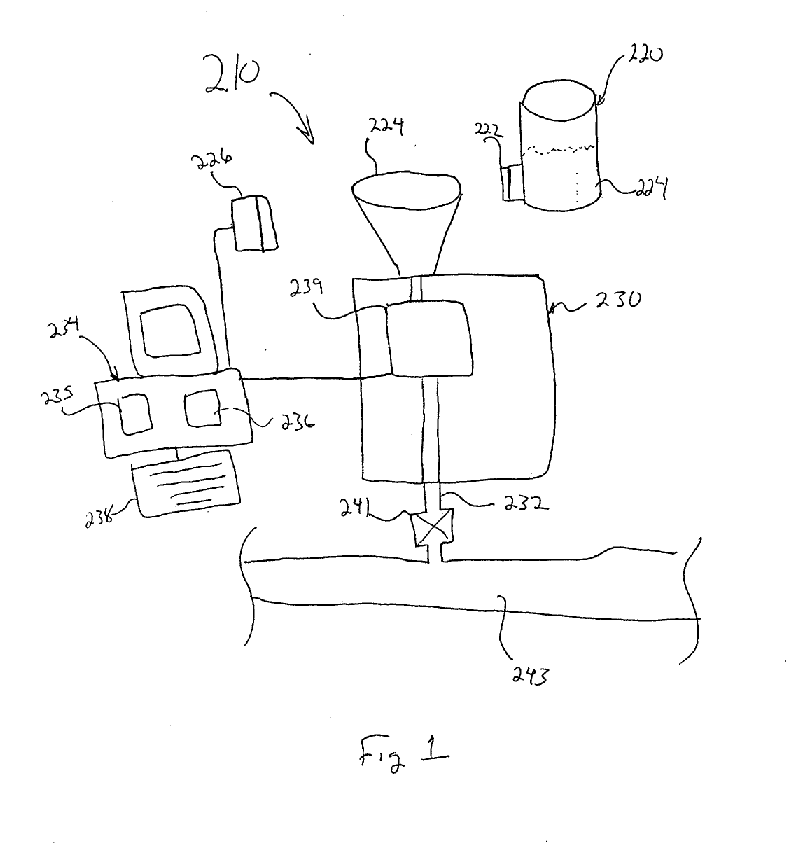

Referring to FIG. 1, an overview of a generic liquid dispensing system wherein a liquid additive is injected into a fluid stream is provided. As shown, the dispensing system 210 includes a dispenser 230 that contains an input port 224 for receiving a supply of a consumable product 220 and an output port 232 utilized for dispensing a predetermined amount of the consumable product 220. The input port 224 may be configured in any number of ways, including an engagement device (e.g., flexible tubing) which interconnects with the container for the consumable product, or a manipulable opening for a container, in which the consumable product may be poured prior to dispensing. Included within the dispensing system 210 may be fluid lines and valve device (not shown) for circulating the consumable product. Also included in the dispensing system 210 is dispenser control 239, which is configurable to control an injector 241 and thereby the amount of consumable product dispensed, such as when the consumable product is mixed with at least one other element, such as fluid stream 243 (e.g., water).

In communication with the dispenser control 239 is controller 234. In the configuration of the invention disclosed in FIG. 1, the controller 234 is a remotely located device having a processor 235 and memory 236 for use in generating control signals for receipt by the dispenser control 239. However, other configurations of the invention may incorporate the controller 239 into the dispenser 230. Included either as part of controller 234, or in direct communication therewith, is product data interface reader 226. Interface reader 226 is configured to read and/or receive product data for the consumable product and provide this information to controller 234. Examples of interface readers include, but are not limited to: magnetic card and/or strip reader, bar code scanner, as well as a manual interface, such as a keypad and/or keyboard, through which a user may enter product data.

In the configuration shown in FIG. 1, the interface reader 226 is configured to read product data on a product data card 222, which is included with the prepackaged consumable product 220. The step of reading may include, but is not limited to, a user removing the card from the product and inserting it in the reader, employing the reader to scan either a card or the container for the product, as well as manually entering product data included with the product, through a keypad and/or keyboard. In another embodiment of the invention described herein the, dispenser 230 may be configured to include an interface reader, wherein upon interconnection of the product container with the dispenser, the product data is read from a data device incorporated into the container.

Once the product data is received by the interface reader 226, it is then sent to the controller 234 for further processing. Using the product data, the controller 234 then transmits one or more control signals to the dispenser control 239 so that the consumable may be injected into the fluid stream 243 in accordance with the information received through the product data interface reader 226. The control signal may at a minimum be simply an activation signal for the dispenser, and possibly include a time period of approved operation for the dispenser. In this regard, the controller may re-activate the dispensing system 230 upon determining the product is available for dispensing. Still further, the control signal may be configured to include detailed commands as to the operation of the dispensing device and the final composition of the consumable and any components with which it is combinable with it. Alternatively, the controller may determine what product has been inserted and retrieve instructions from the memory 236 to determine product-specific dispensing information. In this regard, a protocol stored in a memory 236 may prompt a user to enter one or more dispensing system values via a user interface 238. As shown, the controller 234 is a personal computer; however, it will be appreciated that other controller configurations may be utilized.

Upon receiving the control signals from controller 234, the dispensing system 230 is able to dispense the consumable product 220 in accordance with the information received from the product 220 as well as information (i.e., system requirements) stored by the memory 236. In this regard, the dispensing system 230 may simply dispense a predetermined quantity of the consumable product 220, or, perform one or more processes (e.g., mixing) with the consumable product 220 and dispense a processed product. In another configuration of the invention, the controller may be further configured to generate textual and/or graphical instructions based on the product data. These instruction are presentable on the user interface 238 to the system user. Using these instruction, the system user may then manually control and/or affect the operation of the dispenser 230.

As part of the dispensing process, the controller may be further configured to generate and store log entries relating to the use of the consumable product. For example, when product data for the consumable product is received from the reader 226, relevant information from the product data may then be stored in memory 236. Further, operational information received from the dispenser controller as to the actual dispensing of consumable product/and or operation of the dispenser may be stored.

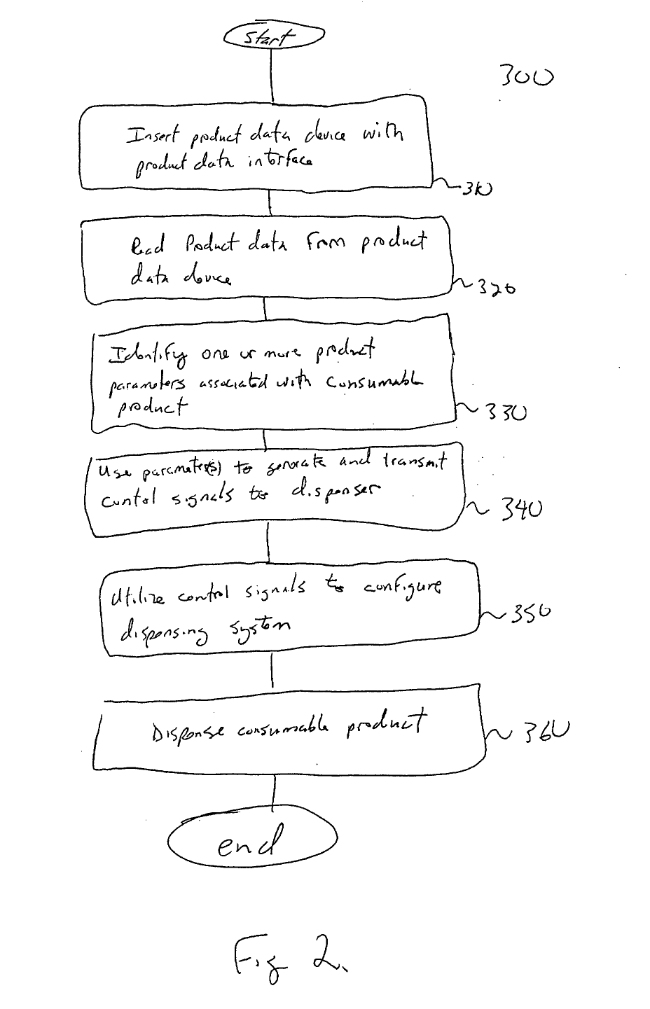

FIG. 2, shows a flow sheet diagram of a method (300) for controllably dispensing a consumable product 220 utilizing the system of FIG. 1. Initially a product data card 222 is inserted (310) into a product data interface 226, which reads (320) product data there from. At this point at least one parameter associated with the consumable product from the product data card 222 is identified (330) for use in dispensing the product 220. A control signal including at least one parameter is then generated and transmitted (340) to the dispenser controller 239. In particular, one or more parameters are utilized by the controller to selectively configure (350) the dispensing system 210 for utilization of the replenishment product 220. Configuring (350) the dispensing system 210 may entail adjusting volumetric settings for use with the consumable product 220, activating the system 210, or, otherwise configure internal processes of the dispensing system 210 for utilizing the consumable product 220. After configuration, the dispensing system 210 dispenses (360) the consumable product in accordance with the product data supplied therewith.

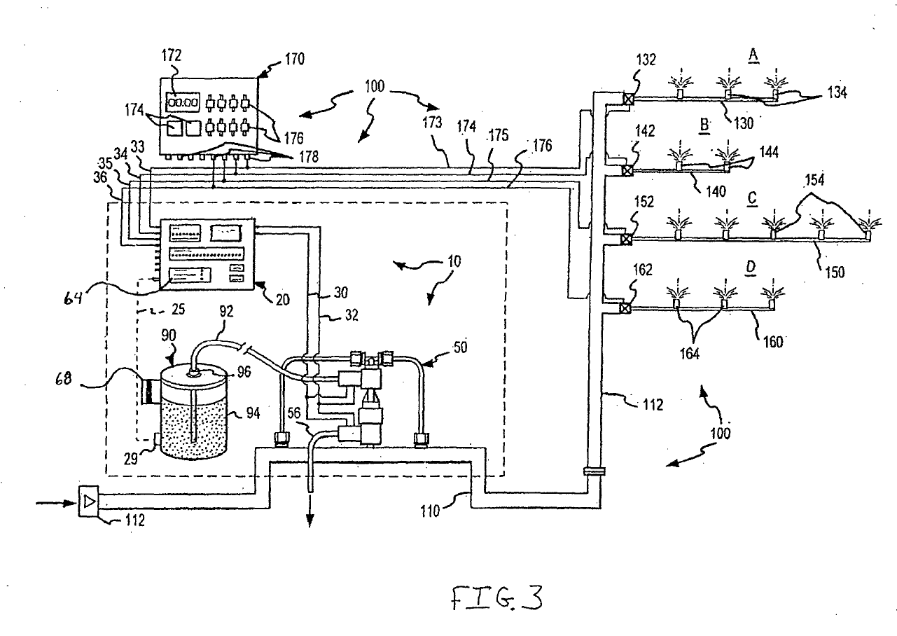

FIG. 3 illustrates one embodiment 10 of the present invention as implemented with an exemplary fertigation/chemigation system 10 packaged and installed with a conventional system 100. A exemplary fertigation/chemigation system incorporated in a sprinkler system is described in U.S. Pat. No. 6,314,979 which is hereby incorporated by reference. Alternatively, the fertigation/chemigation system 10 may be readily implemented to interface with a previously installed conventional sprinkler system. Further, the described embodiment 10 comprises features that may be readily adapted for use in connection with liquid dispensation systems other than the illustrated exemplary system 100. For example, the present invention may be utilized in connection with hydroponic growth systems and tank-fed, sprayer systems.

In the exemplary watering system 100, a main watering system line 110 is fluidly interconnected to a main water supply (e.g. a city water supply or pump supply line) via valve 112, wherein water within the main water line 110 is “pressurized”. Pressurization within the main water line 110 may also be provided via one or more dedicated pumps for the watering system. The main water line 110 is fluidly interconnected by a manifold 112 to a series of watering zone feed lines 130, 140, 150 and 160, via corresponding solenoid valves 132, 142, 152 and 162, respectively. Each of the zone feed lines 130, 140, 150 and 160 supply one or more corresponding water emitters (e.g. spray heads, drip heads, etc.) 134, 144, 154 and 164, respectively. The selective actuation, or opening/closing, of solenoid valves 132, 142, 152 and 162 may be effected via the transmission of electrical control signals by a main controller 170 through corresponding control signal lines 173, 174, 175 and 176, so as to effect the desired watering of corresponding watering zones A, B, C and D, respectively.

In the exemplary watering system 100, controller 170 includes a control clock 172, programming input keys 174, and duration-setting controls 176. The programming input keys 174 and duration-setting controls 176 may be utilized to establish one or more desired start time(s) for the watering system and the desired length of each watering period for each of the watering zones A-D serviced by corresponding solenoid valves 132, 142, 152 and 162, respectively. While the programmable controller 170 shown in FIG. 3 includes eight durational control knobs 176, and corresponding control signal line output ports 178 (e.g. to service up to eight corresponding watering zones), controller 170 may be provided with more/less zone control knobs/output ports. Similarly, while FIG. 3 shows an exemplary watering system 100 servicing four watering zones A-D, more/less zones may be readily defined in corresponding relation to the number of zone watering controls provided by a given controller 170.

Most typically, the control clock 172 of controller 170 will be set in accordance with real clock time and program input keys 174 will be utilized to establish one or more set times to initiate automatic operation of the system. Upon initiation of a watering cycle, controller 170 may be programmed to automatically transmit control signals through control lines 173, 174, 175 and 176 in a successive manner, wherein valve 132 stays open for a durational period set by the corresponding control 176 for zone A, then valve 132 closes and valve 142 is opened for a durational period set via the corresponding control 176 for zone B, and so on. Numerous additional features and configurations of exemplary watering system 100 will be known to those skilled in the art and are employable with the present invention, including the described embodiment 10.

In the later regard, the exemplary fertigation/chemigation system 10 shown in FIG. 3 includes a programmable injection controller 20, injection assembly 50, and liquid additive containment assembly 90. The exemplary fertigation/chemigation system injects consumable horticultural product 94 from the containment assembly 90 through its injector 50 into the irrigation system in accordance with information programmed into its controller 20, and is capable of delivering different amounts of product into different zones of the irrigation system 100. The system does not necessarily alter the watering cycles of the irrigation system controller 170, but instead, through controller 20, controls exemplary fertigation/chemigation system 10 as it delivers a consumable product 94 into these irrigation zones. Numerous additional features and configurations of exemplary watering systems 100 and exemplary fertigation/chemigation system 10 will be known to those skilled in the art and are employable with the present invention, including the described embodiment.

In accordance with the present invention, the injection controller 20 contains a product data interface, which in the present embodiment is a magnetic swipe card reader 64 (as will be discussed herein). Injection assembly 50 is fluidly interconnected to the main watering system line 110 as well as the liquid additive containment assembly 90. Further, injection assembly 50, is electrically interconnected to injection controller 20 via injection signal circuit lines 30 and 32. In turn, injection controller 20 is electrically interconnected to the main watering system controller 170 via signal sensing lines 33, 34, 35 and 36. More particularly, signal sensing lines 33, 34, 35 and 36 are interconnected in parallel to control signal lines 173, 174, 175 and 176, respectively. As will be further described, injection assembly 50 operates to successively draw a predetermined amount, or “slug”, of liquid additive from containment assembly 90 and inject such “slugs” into the main water line 110 of exemplary watering system 100 in response to electrical pulses received via injection signal circuit lines 30 and 32 from injection controller 20. The injection pulses are transmitted by injection controller 20 at a predetermined rate that is selectable by a user on a watering zone-specific basis, in response to sense signals received from the controller 170 via the parallel interconnections between the sensing signal lines 33-36 and corresponding control signal lines 173-176.

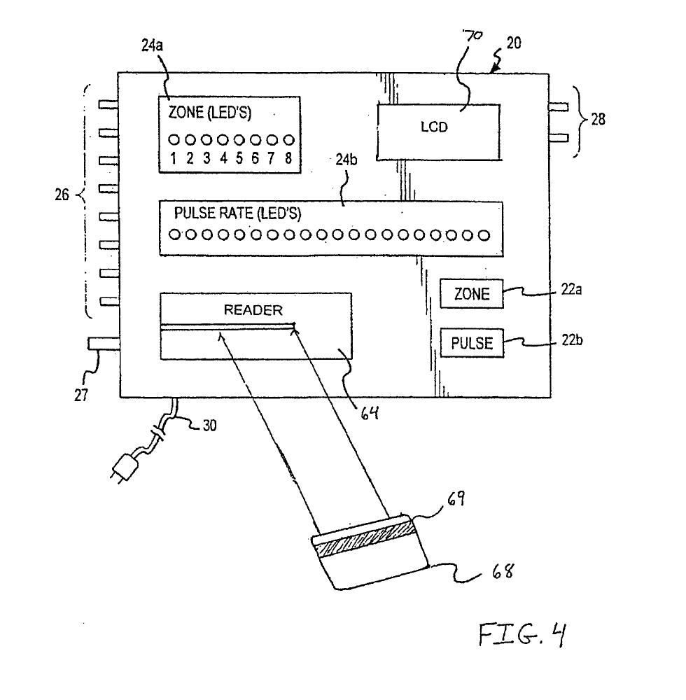

As noted, the controller 20 contains the magnetic swipe card reader 64 for receiving product data information associated with the liquid additive containment assembly 90. In this regard, it will be appreciated that liquid containment assembly 90 is a replaceable containment assembly that is replaced after depletion the additive contained therein. Associated with the liquid containment assembly 90 is a product data card 68 for providing liquid additive data to the card reader 64 of the controller 20. As shown in FIG. 1, the product data card 65 is releaseably attached to the side of the liquid additive containment assembly 90; however, the product data card 68 may be integrated into the liquid additive containment 90 assembly in any appropriate manner. In any case, upon replacing the liquid additive container 90, a user detaches the card 64 and runs the magnetic stripe 69 through the magnetic card reader 64 to provide product information to the controller 20 (see FIG. 4). For example, the horticulture injecting system 10 may inject additives into the system in one-milliliter pulses. In this regard, the product data card 64 may provide information as to the volume of the additive interconnected to the system 10. For example, if a one-gallon container were added to the system 10, the product data card 64 would inform the controller 20 that 3,785 one-milliliter injections (i.e. one gallon) are available for insertion into the main water line 110. Further, the data card 64 may provide concentration information regarding the additive to allow the controller 20 to adjust the rate of injection of the one-milliliter pulses into the main water line to achieve a desired water/additive mixture. Upon depleting the additive within the fluid containment assembly 90, the controller 20 may shut down the injection system 10 to prevent undue wear to the components of the system 10. Alternatively, the controller 20 may deactivate the system 10 upon depleting each liquid additive containment assembly and not allow the system 10 to be utilized until a valid product data card 68 is inserted into the data card reader 64. As will be appreciated, this prevents utilization of improper/unauthorized products with the injection system 10. For example, requiring a data card reader 64 to activate the system prevents utilization of the system for, inter alia, application of products for which the system is not designed (e.g. pesticides or overly concentrated products).

FIG. 4 shows a close-up view of the exemplary fertigation/chemigation controller 20 utilized in the present embodiment 10. As shown, the controller 20 includes a zone LED readout 24a, which indicates the current zone activated within the lawn sprinkler system 100, zone 22a and pulse 22b controller keys for selecting a zone and manually setting pulse rates (i.e. injection rate) for the liquid additive. That is, the zone 22a and pulse 22b keys allow a user to program the controller 20. Additionally, the controller contains first interface 26 for selective interconnection to the main controller 170 as well as a second interface 28 for connection to the injector system. In accordance with the present invention, the controller 20 contains a data card reader 64 for selectively receiving a product data card 68 that contains a magnetic strip memory 69. As will be appreciated, the product data card 68 is inserted into the reader to allow the controller 20 to read product-specific information as well as system configuration information. The controller also contains a display 70 for displaying information associated with the product data card 68 or otherwise requesting user input. In this regard, the zone 22A and pulse 22B controllers may be utilized to input system specific information in response to prompts provided by the display 70. As shown, the product data interface 64 as well as the output display 70 are integrated into the controller 20. However, it will be appreciated a separate unit containing a product data interface 64 and output display 70 may be retrofit onto an existing controller through an interface (i.e. first interface 26) associated with the controller. In this regard, existing systems may utilize the product data interface system of the present invention to allow for more controlled dispensing of consumable products.

The above-described embodiments are in no way intended to limit the scope of the present invention. Numerous extensions and adaptations of the invention will be apparent to those skilled in the art.

What is claimed is:

1. A system for controllably dispensing a consumable product, said system comprising:
a dispenser for receiving a prepackaged supply of a consumable product, wherein said dispenser is operable to selectively perform at least one process utilizing said consumable product;
a controller for transmitting control signals to control the operation of said dispenser; and
a product data interface in data communication with said controller, for receiving at least one product data parameter from a product data source associated with said prepackaged supply of said consumable product, wherein said at least one data parameter is selectively utilizable by said controller for controlling said dispenser.

2. The system as claimed in claim 1, wherein said product data interface comprises an electronic reader for reading said at least one product data parameter from an electronic data storage device associated with said prepackaged supply of said consumable product.

3. The system as claimed in claim 2, wherein said product data interface comprises a magnetic data card reader for reading said at least one product data parameter from a magnetic data card associated with said prepackaged supply of said consumable product.

4. The system as claimed in claim 2, wherein said product data interface comprises an integrated chip reader for reading said at least one product data parameter from an integrated chip associated with said prepackaged supply of said consumable product.

5. The system as clamed in claim 1, wherein said product data interface is in data communication with said controller via an air interface.

6. The system as claimed in claim 1, wherein said product data interface automatically reads said at least one product data parameter from said product data source upon said prepackaged supply of said consumable product being interfaced with said dispenser.

7. The system as claimed in claim 1, wherein said controller is operative to utilize said at least one data parameter to configure said dispenser according to a predetermined protocol.

8. The system as claimed in claim 1, wherein said controller is operative to disable said dispenser when said at least one data parameter is outside a predetermined acceptable range.

9. The system as claimed in claim 1, further comprising:
a memory structure in communication with said controller, wherein said memory structure is operative to store at least one of: product data information and dispenser configuration information.

10. The system as claimed in claim 7, wherein said memory structure is in communications with said controller via a communications network.

11. The system as claimed in claim 7, further comprising:
a user interface, said user interface providing at least a first user output and at least a first user input.

12. The system as claimed in claim 11, wherein user instructions associated with said at least one product data parameter are provided via said user interface.

13. The system as claimed in claim 12, wherein said user instructions prompt a user to enter information for use in configuring said dispenser for use with said consumable product.

14. A method for dispensing a consumable product through a dispensing system, wherein said dispensing system includes a configurable controller for selectively controlling the operation of the dispensing system, said method comprising;
interfacing a prepackaged supply of a consumable product to a product input port of said dispensing system;
reading, at a product data interface of said dispensing system, at least one data parameter from a product data source associated with said prepackaged supply of said consumable product;
utilizing said at least one data parameter from said product data source to configure said dispensing system to utilize said supply of said consumable product.

15. The method of claim 14, wherein said step of reading comprises interfacing a product data source from said prepackaged supply of said consumable product with said product data interface.

16. The method of claim 15, wherein said step of reading further comprises removing said product data source from said prepackaged supply of said consumable product prior to said step of interfacing.

17. The method of claim 14, wherein said step of reading comprises reading a magnetic data card associated with said prepackaged supply of said consumable product.

18. The method of claim 14, wherein said step of reading at least one data parameter comprises reading at least one of product data information and dispensing system calibration information.

19. The method of claim 18, wherein said product data information includes at least one of product identification information, product expiration information, product ingredient information and volumetric data information.

20. The method of claim 19, further comprising, utilizing said product data information to access additional information for use in configuring said dispensing system.

21. The method of claim 19, wherein said dispensing system calibration information includes dosage information for said consumable product.

22. The method of claim 14, wherein said step of reading said at least one data parameter from a product data source further comprises:
providing a display at a user interface prompting at least one user input.

23. The method of claim 22, wherein said utilizing step comprises utilizing said at least one data parameter and said at least one user input to configure said dispensing system.

24. A system for controllably injecting a liquid additive into a liquid stream, comprising:
a replaceable prepackaged supply of liquid additive;
an injector in fluid communication with said supply of liquid additive, said injector operable to inject a predetermined dosage of said liquid additive into said fluid stream in response to received control signals;
a product data interface for receiving at least one product data parameter from a data source associated with said prepackaged supply of liquid additive;
a controller in data communication with said product data interface, wherein said controller is operative to utilize said at least one product data parameter in creating said control signals for use in selectively operating said injector.

25. The system of claim 24, wherein said product data interface comprises an electronic reader operable to read said at least one data parameter from an electronic data storage source.

26. The system of claim 25, wherein said electronic reader comprises a magnetic card reader and said electronic data storage source comprises a magnetic data card.

27. The system of claim 24, wherein said data source is associated with the packaging of said prepackaged supply of liquid additive.

28. The system of claim 27, wherein said data source is selectively removable from said packaging for interfacing with said product data interface.

29. The system of claim 24, wherein said controller is operative to compare each said product data parameter to a corresponding allowable data parameter range.

30. The system of claim 29, wherein said controller is operative to disable said system if at least one said product data parameter is outside said allowable data parameter range.
